(19) United States
(12) Patent Application Publication
(10) Pub. No.: US 2026/0088481 A1
(43) Pub. Date: Mar. 26, 2026

(54) DISTRIBUTED ELEMENT RADIO FREQUENCY FILTER

(71) Applicant: Knowles Cazenovia, Inc., Cazenovia, NY (US)

(72) Inventor: Jared P. BURDICK, Fayetteville, NY (US)

(21) Appl. No.: 18/895,608

(22) Filed: Sep. 25, 2024

(51) Int. Cl. H01P 1/203

(52) U.S. Cl. CPC H01P 1/20381

(57) ABSTRACT

A distributed element radio frequency (RF) filter includes one or more fully grounded half-wave resonators located between first and second resonators electrically coupled to corresponding input/output (I/O) interfaces proximate corresponding ends of a dielectric substrate. Each of the one or more half-wave resonators comprise a U-shaped or omega-shaped resonator portion located between first and second end portions electrically connected to a ground plane at a common side of the substrate. Each resonator has an electrical length that is nominally one-half a wavelength of a center frequency of the filter. The filter can optionally include a conductive cover over the resonators.

### FIELD OF THE DISCLOSURE

The present disclosure relates generally to radio frequency (RF) filters and more particularly to distributed element RF filters comprising grounded half-wave resonators.

### BACKGROUND

Distributed element RF filters generally comprise thick or thin-film resonators and other conductive elements deposited on a dielectric substrate. Such filters are typically integrated with a microstrip or other impedance-controlled transmission line on a printed circuit board (PCB) and commonly used at or near the front-end of communications and radar systems, among others, where insertion loss, frequency selectivity and power considerations are paramount. One such distributed element RF filter is a quarter-wave bandpass filter comprising partially grounded resonators having one end grounded (short circuited) and the other end ungrounded (open circuited). However, quarter-wave resonators tend to result in less than desirable insertion loss, stopband rejection, and deviation from a desired flat and low-loss passband. Thus, there is a desire to provide improved distributed element RF filters having one or more of lower insertion loss, improved frequency selection among other desirable characteristics.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and implementations and are not considered to limit application of the teachings of the disclosure, the scope of which is set forth by the appended claims.

FIG. 1 is a perspective view of a representative distributed element RF filter.

FIG. 2 is a plan view of the RF filter of FIG. 1 without a cover.

FIG. 3 is a plan view of a distributed element RF filter comprising an alternative resonator configuration.

FIG. 4 is a plan view of a distributed element RF filter comprising another resonator configuration.

FIG. 5 is a plan view of a distributed element RF filter comprising yet another resonator configuration.

FIG. 6 is a plan view of a distributed element RF filter comprising still another resonator configuration.

FIG. 7 is a plan view of a distributed element RF filter comprising another resonator configuration.

FIG. 8 is a plan view of a distributed element RF filter comprising another alternative resonator configuration.

FIG. 9 is a bottom plan view of the ground plane of the RF filter of FIG. 1.

FIG. 10 is a side view of a representative distributed element RF filter.

FIG. 11 is an end view of a distributed element RF filter comprising a cover.

FIG. 12 illustrates comparative simulated passband plots for a prior art bandpass filter having partially grounded quarter-wave resonators and a bandpass filter having fully grounded half-wave resonators according to the present disclosure.

Those of ordinary skill in the art will appreciate that the drawings are illustrated for simplicity and clarity and therefore may not be drawn to scale and may not include well-known features, that the order of occurrence of actions or steps may be different than the order described that some or all of such actions or steps may be performed concurrently unless specified otherwise, and that the terms and expressions used herein have meaning understood by those of ordinary skill in the art except where a different meaning is specifically attributed to them.

### DETAILED DESCRIPTION

The disclosure relates generally to radio frequency (RF) including microwave filters and more particularly to distributed element RF filters comprising grounded half-wave resonators on a dielectric substrate mountable on a printed circuit board (PCB) or on some other host device or system. Such filters can be configured as microstrip, stripline, or other impedance-controlled transmission lines. Representative distributed element RF filters are described further herein. In this specification, RF includes microwave frequencies.

The resonators and other conductors of distributed element RF filters can be deposited as thick-films or thin-films on the substrate using well known fabrication processes. Thick-film filter elements typically have a thickness in a range between 0.5 thousandths (mils) and 2.0 mils and can be formed of a metallic paste screen printed on the substrate, among other known and future processes. Thin-film deposits can be patterned by various means and deposited on the substrate by chemical vapor deposition, e-beam deposition, or sputtering, among other known and future deposition processes. Thin-film filters typically have a thickness of roughly two skin depths. A “skin depth” is the depth at which current density is about 1/e of current density at a surface of the conductive film. A film thickness less than two skin depths may adversely affect insertion loss. A thickness of 3 to 5 skin depth is typical. A greater film thickness may not provide an appreciable benefit and may degrade the accuracy of metal deposition. In a 10 GHz filter having a conductive film with good conductivity (e.g., copper, silver, gold...) four skin depths is on the order of 0.10 mil. Alternatively, the resonators can be formed by laser or chemical etching a pattern projected onto the substrate. The resonators can also be formed from a rolled or electrolytic conductor foil adhered to a printed circuit board or other substrate.

In one implementation, a distributed element RF bandpass filter comprises a dielectric substrate between a ground plane at one surface of the substrate and a plurality of resonators at an opposite surface of the substrate. One or more intermediate resonators can be located between first and second resonators electrically coupled to corresponding input/output (I/O) interfaces proximate corresponding ends of the substrate. In bandpass filters, each of the one or more intermediate resonators can have an electrical length that is nominally one-half a wavelength of a center frequency of the bandpass filter.

The one or more intermediate resonators each comprise a resonator portion between first and second resonator end-portions electrically connected to the ground plane by one or more conductors proximate a common side of the substrate, wherein each of the one or more intermediate resonators at least partially surrounds a corresponding portion of the surface of the substrate on which the resonator is located.

Dielectric materials suitable for the RF filters disclosed herein generally have a relatively high quality (Q) factor and a stable temperature coefficient. A representative dielectric material has a Q factor greater than 400. One representative dielectric material is a high purity aluminum oxide (aka “alumina”) ceramic, which can have a Q factor as high as 5000 and a relative dielectric constant of about 10. Other known and future ceramics, among other dielectric materials, can also be used for the RF filters described herein.

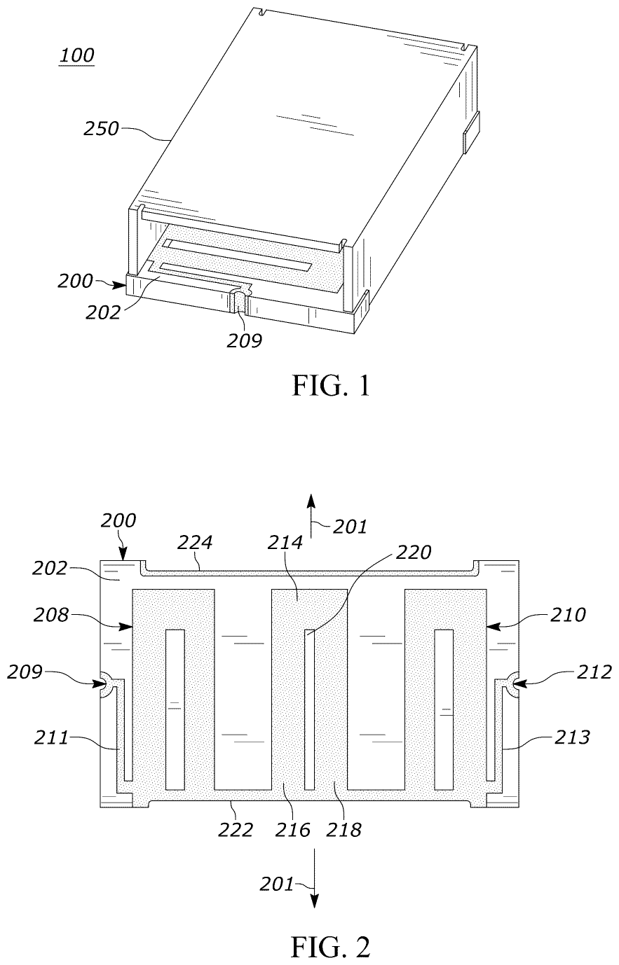

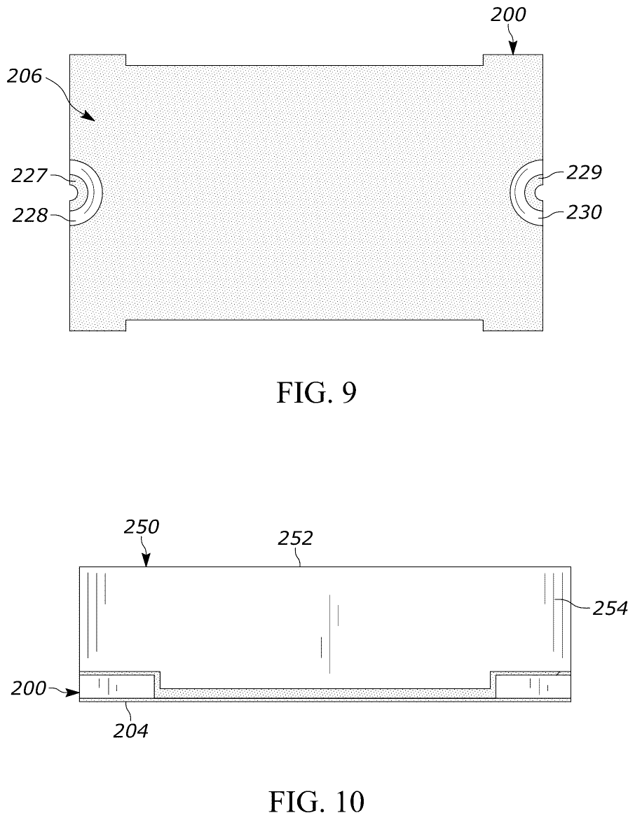

FIG. 1 is a representative distributed element RF bandpass filter 100 configured as a microstrip transmission line comprising a dielectric substrate 200 between multiple resonators on one side and a ground plane on an opposite side. FIGS. 2-8 best show the resonators located on a top surface 202 of the substrate opposite a bottom surface 204 on which the ground plane 206 (shown in FIGS. 9-11) is located. Adjacent resonators are separated by a gap or space on the dielectric. In FIGS. 2-8, a first resonator 208 is electrically coupled to an input/output (I/O) interface 209 proximate a first end of the substrate, and a second resonator 210 is electrically coupled to an I/O interface 212 proximate a second end of the substrate. One or more fully grounded half-wave intermediate resonators are located between the first and second resonators 208 and 210 electrically coupled to the I/O interfaces. In other implementations, the filter can be configured as a stripline wherein the resonators are sandwiched between top and bottom ground planes interconnected by conductive vias. In FIGS. 2-8, for example, the filter can be configured as a stripline by adding a second dielectric substrate and second ground plane on top of the resonators.

Electromagnetic coupling between and among the resonators is a function of the dielectric gap between resonators. In embodiments comprising multiple intermediate resonators, reflections due to impedance mismatch can be reduced by providing a relatively large dielectric gap between the one or more intermediate resonators and providing a relatively small dielectric gap between the end-most intermediate resonators and the resonators (e.g., 208 and 210) coupled to the I/O interfaces. The filter order is associated with the number of resonators. FIGS. 2-8 illustrate third order bandpass filters comprising three resonators. Higher order filters can result from additional resonators.

In one implementation, the distributed element RF bandpass filter is a thin-film multi-pole bandpass filter having a passband between 1 GHz and 60 GHz, and the one or more intermediate resonators have an unloaded Q factor greater than 400.

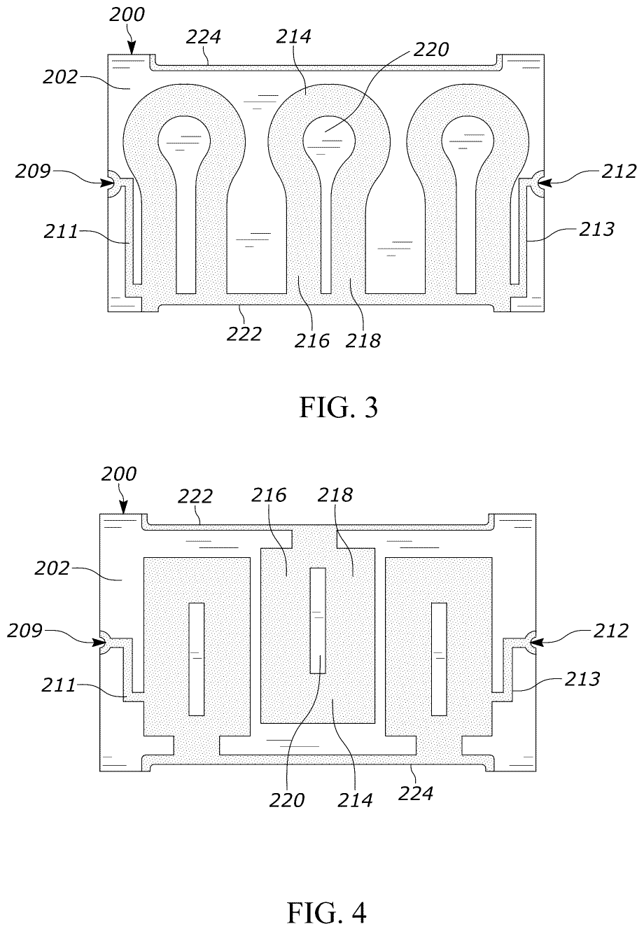

In FIGS. 2-8, each of the one or more intermediate resonators generally comprises a resonator portion 214 between first and second end portions 216 and 218 connected to the ground plane by one or more conductors located proximate a common (i.e., the same) side of the substrate. Thus configured, each resonator is fully grounded and at least partially surrounds a portion 220 of the substrate surface on which the resonator is located. The resonator portion 214 can have a U-shape or an omega-shape, among others, as shown in FIGS. 2 and 3, respectively.

In FIGS. 2-8, each of the first and second resonators 208 and 210 coupled to the corresponding I/O interfaces comprise a resonator portion between first and second end-portions connected to the ground plane by a conductor on one side of the substrate as described herein. Thus configured, the first and second resonators and the one or more intermediate resonators of the RF filter have the same shape. Alternatively, the first and second resonators can have a configuration or shape different than the shape of the one or more intermediate resonators. Generally, the resonators can be arranged symmetrically on the surface 202 of substrate about a reference (e.g., a midpoint 201 shown in FIG. 1) between the I/O interfaces 209 and 212, wherein the resonators on one side of the reference are a mirror image of resonators on the other side of the reference. The symmetrical configuration of the resonators can improve filter performance.

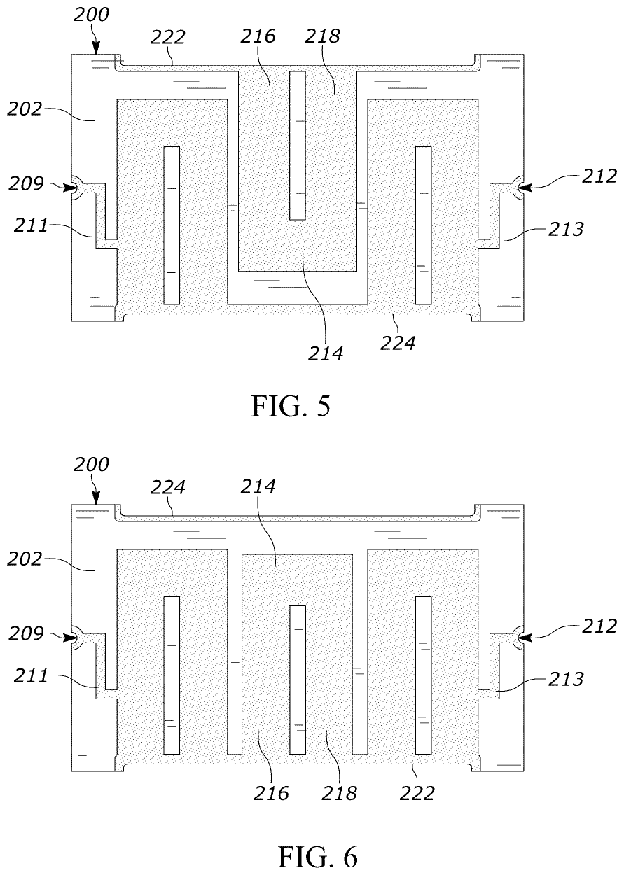

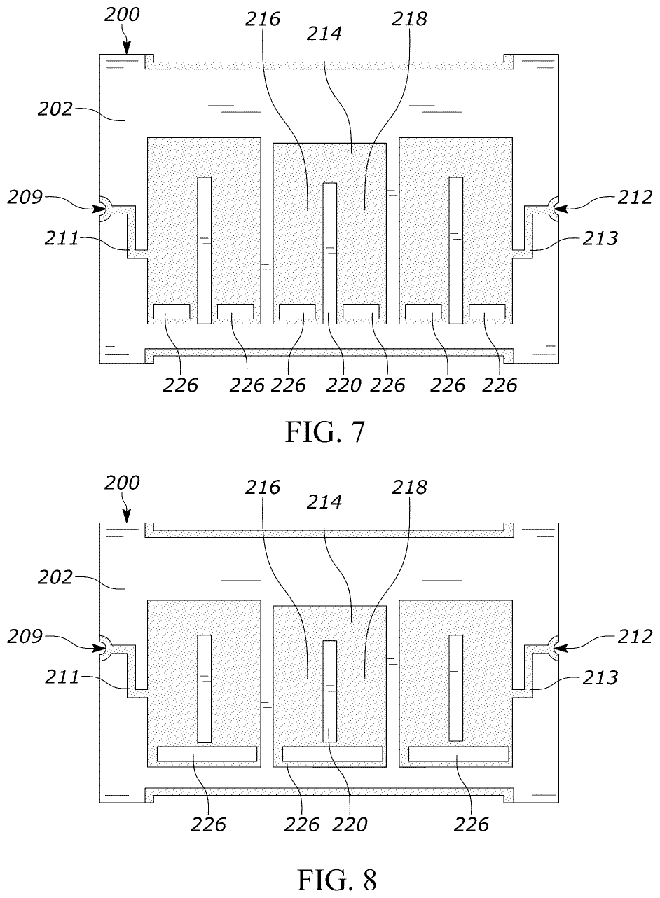

Insertion loss can be reduced if the resonators are directly coupled to the ground plane by one or more conductors rather than by capacitive coupling. The one or more conductors electrically connecting the first and second end portions of the resonators to the ground plane can constitute a conductive wall proximate a common side of the substrate. In FIGS. 2-8, a first conductive wall 222 is disposed on a first outer sidewall of the substrate, and a second conductive wall 224 is disposed on a second outer sidewall, opposite the first outer sidewall of the substrate. In FIGS. 2-3 and 6, the conductive wall 222 extends between the ground plane and the first and second end portions 216 and 218 of each resonator. In FIGS. 4-5, the first conductive sidewall 222 connects the end portions 216 and 218 of the intermediate resonator to the ground plane, and the second conductive sidewall 224 electrically connects the end portions of the first and second resonators, coupled to the I/O interfaces, to the ground plane. In FIGS. 7-8, the one or more conductors comprise a series of discrete vias 226 extending through the substrate adjacent the first outer sidewall. The discrete vias electrically connect the first and second end portions 216 and 218 of the resonators to the ground plane on the opposite surface of the substrate. The conductive sidewalls or conductive vias can comprise thick-films or thin-films deposited on select surfaces (e.g., outer sidewalls or vias) of the dielectric substrate.

The electrical length of a resonator depends generally on the physical length of the resonator and the wavelength of the signal at a particular frequency or band of frequencies. In one implementation, at least the one or more intermediate resonators have an electrical length that is nominally one-half a wavelength of a center frequency of the bandpass filter, as described herein. The first and second resonators can also have an electrical length that is nominally one-half a wavelength of the center frequency. The term “nominally” means that the electrical length of the resonator can be as much as 8% more or less than one-half the wavelength of the center frequency of the bandpass filter. The resonators connected to the I/O interfaces can also have an electrical length that is nominally one-half the wavelength of the center frequency.

In one implementation, all resonators have the same electrical length. In other implementations, the resonators have different electrical lengths. For example, the one or more intermediate resonators can have a common electrical length that differs from the electrical length of the first and second resonators. The electrical length of the first and second resonators, connected to the I/O interfaces, can be greater than the electrical length of the one or more intermediate resonators to compensate for electrical loading by the I/O interfaces and external devices, among other sources. In FIGS. 6-8, the first and second resonators coupled to the I/O interfaces have a common length that is longer than the one or more intermediate resonators. Increasing the width of the resonators connected to the I/O interfaces relative to the width of the one or more intermediate resonators can also compensate for electrical loading. For example, the first and second resonators can have a length-to-width aspect ratio that is less than a length-to-width aspect ratio of the one or more intermediate resonators. In one implementation, the one or more intermediate resonators have a length-to-width aspect ratio not greater than 10.

In FIGS. 2-8, the I/O interfaces are directly electrically connected to the resonators by corresponding conductive traces 211 and 213, respectively. Alternatively, the I/O interfaces can be coupled to the resonators by one or more intermediate capacitive elements. The term “coupled” used herein means capacitive coupling or direct electrical connection (i.e., non-capacitive coupling) by a conductive trace. The I/O interfaces each generally comprise a corresponding castellation extending through the substrate 200 between the surfaces on which the resonators and ground plane are located. In FIGS. 2-9, first and second castellations 209 and 212 are shown formed on corresponding end walls of the substrate 200. Alternatively, the castellations can be configured as vias located inwardly of the end walls. Each castellation includes a flange portion on each of the opposite surfaces of the substrate. In FIGS. 2-8, the flange portions on the surface 202 are connected to corresponding conductive traces connected to a corresponding resonator. In FIG. 9, the flange portions 227 and 229 of the castellations are separated from the ground plane 206 by corresponding gaps 228 and 230, respectively. The ground plane 206 and flange portions of the castellations can be electrically connected to corresponding conductors of a host device (e.g., contacts on a PCB) by surface mounting the RF device in a reflow, wave soldering or other assembly process. In other implementations, alternatively, the I/O interfaces can be located on a side of the substrate or on the same surface as the resonators and electrically connected to a host circuit by wire bonding or other conductor connecting technology. In RF and microwave filters, a characteristic impedance at the I/O interface is typically 50 Ohms. In other filters however the impedance at the I/O interface can be other than 50 Ohms, depending on the use case.

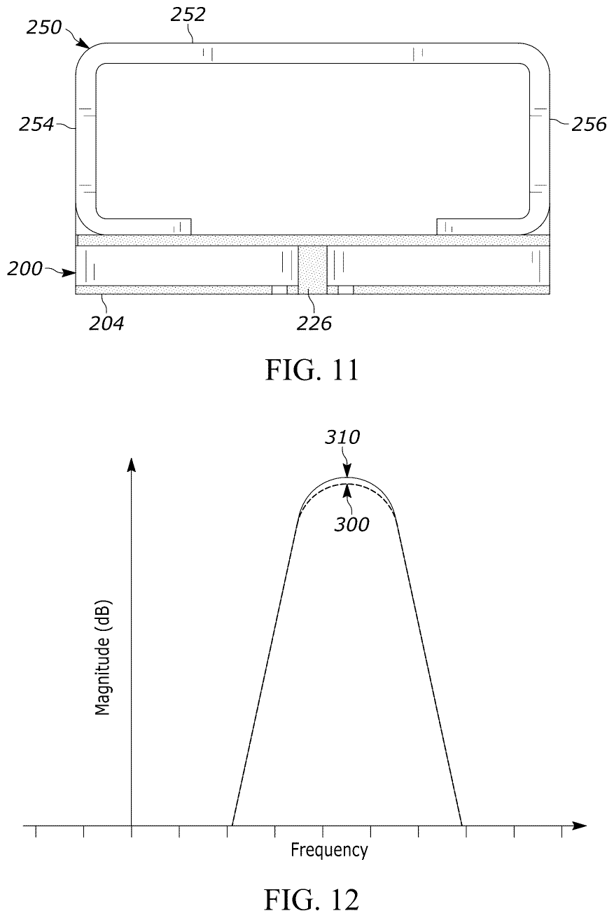

In some implementations, optionally, a conductive cover is placed over the resonators on the dielectric substrate, effectively creating a waveguide. In some implementations the conductive cover can improve filter performance. In FIGS. 10-11, the filter includes a cover 250 covering a portion of the resonators on the substrate 200. The cover comprises a metal or other conductive material having a top wall 252 and opposite side walls 254 and 256 electrically connected to the ground plane via the conductive side walls. In FIG. 10, the side walls of the cover are connected to the corresponding conductive side wall of the substrate. Ends of the cover can remain open so that there is a passage beneath the cover.

FIG. 12 illustrates a simulated passband plot 300 for a prior art 4-pole distributed element RF bandpass filter having quarter-wave resonators and a simulated passband plot 310 for a representative 4-pole distributed element RF bandpass filter having half-wave resonators of the type shown in FIG. 2 and described herein. Both filters comprise a 0.02 inch thick ceramic substrate with a dielectric constant of about 25. Both filters comprise a 0.1 mil thin-film metallization layer. The resonators of the quarter-wave filter are connected to the ground plane by conductive vias. The resonators of the half-wave filter are connected to the ground plane by a metallized side wall of the type shown in FIG. 2. The half-wave filter has a higher Q factor than the quarter-wave filter, resulting in an insertion loss of about 1.7 dB for the half-wave filter compared to an insertion loss of about 2.1 dB for the prior art quarter-wave filter.

In one implementation, a distributed element radio frequency (RF) filter comprises a ceramic substrate having a ground plane on a first surface of the substrate and first and second resonators on a second surface, opposite the first surface of the substrate. The first resonator is electrically connected to a first input/output (I/O) interface proximate a first end of the substrate, and a second resonator on the second surface of the substrate is electrically connected to a second I/O interface proximate a second end, opposite the first end of the substrate. One or more intermediate resonators on the second surface of the substrate are located between the first and second resonators. Each of the first, second and one or more intermediate resonators having an electrical length that is nominally one-half a wavelength of a center frequency of the filter. Each of the first, second and one or more intermediate resonators comprise a resonator portion between first and second resonator end portions electrically connected to the ground plane by a conductive wall proximate a common side of the substrate, wherein each resonator at least partially surrounds a portion of the surface of the substrate on which the resonator is located.

Each resonator portion can comprise a U-shaped resonator portion or an omega-shaped resonator portion. The first, second and one or more intermediate resonators are all electrically connected to the ground plane by a common conductive wall configured as multiple vias extending through the substrate or a metallized sidewall of the substrate.

In another implementation, a distributed-element radio frequency (RF) filter comprises a dielectric substrate comprising a ground plane located on a surface of the substrate, and first and second resonators located on a surface of the substrate opposite the ground plane. Each of the first and second resonators are electrically coupled to a corresponding input/output (I/O) interface proximate a corresponding end of the substrate. One or more U-shaped or omega-shaped resonators are located on the surface of the substrate opposite the ground plane and between the first and second resonators. Each U-shaped or omega-shaped resonator comprising first and second resonator end portions electrically connected to the ground plane by one or more conductors proximate a common side of the substrate, wherein each resonator has an electrical length that is nominally one-half a wavelength of a center frequency of the filter.

A distributed-element radio frequency (RF) filter comprises a dielectric substrate between a ground plane at a surface of the substrate and a plurality of resonators at an opposite surface of the substrate. The plurality of resonators comprise first and second resonators electrically coupled to a corresponding input/output (I/O) interface proximate a corresponding end of the substrate, and one or more intermediate resonators located between the first and second resonators. Each of the one or more intermediate resonators comprises a resonator portion between first and second end portions electrically connected to the ground plane by one or more conductors proximate a common side of the substrate.

In the various distributed element RF filter implementations described herein, the first and second resonators can have a common same electrical length, and the one or more intermediate resonators can have a common electrical length. The electrical length of the first and second resonators can be greater than the electrical length of the one or more intermediate resonators. And the first and second resonators can have a length-to-width aspect ratio less than a length-to-width aspect ratio of the one or more intermediate resonators.

The various distributed element RF filters described herein can optionally comprise a conductive cover fastened to the substrate and electrically connected to the ground plane, wherein the conductive cover is disposed over a surface of the substrate on which the resonators are located.

Any of the distributed element RF filters described herein can be a thin-film multi-pole filter having a passband between 1 GHz and 60 GHz, and the one or more intermediate resonators have an unloaded quality factor (Q) greater than 400, among others described herein.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. A distributed-element radio frequency (RF) filter comprising:
a ceramic substrate having a ground plane on a first surface of the substrate;
a first resonator on a second surface, opposite the first surface, of the substrate, the first resonator electrically connected to a first input/output (I/O) interface proximate a first end of the substrate;
a second resonator on the second surface of the substrate, the second resonator electrically connected to a second I/O interface proximate a second end, opposite the first end, of the substrate;
one or more intermediate resonators on the second surface of the substrate, the one or more intermediate resonators located between the first and second resonators,
each of the first, second and one or more intermediate resonators having an electrical length that is nominally one-half a wavelength of a center frequency of the filter,
each of the first, second and one or more intermediate resonators comprising a resonator portion between first and second resonator end portions electrically connected to the ground plane by a conductive wall proximate a common side of the substrate, wherein each resonator at least partially surrounds a portion of the surface of the substrate on which the resonator is located.

2. The distributed-element RF filter of claim 1, wherein each resonator portion comprises a U-shaped resonator portion.

3. The distributed-element RF filter of claim 1, wherein each resonator portion comprises an omega-shaped resonator portion.

4. The distributed-element RF filter of claim 1, wherein the first, second and one or more intermediate resonators are all electrically connected to the ground plane by a common conductive wall.

5. The distributed-element RF filter of claim 1, wherein the first and second resonators have a common electrical length, and the one or more intermediate resonators have a common electrical length.

6. The distributed-element RF filter of claim 1, wherein an electrical length of the first and second resonators is greater than an electrical length of the one or more intermediate resonators.

7. The distributed-element RF filter of claim 5, wherein the first and second resonators have a length-to-width aspect ratio less than a length-to-width aspect ratio of the one or more intermediate resonators.

8. The distributed-element RF filter of claim 1 is a thin-film multi-pole filter having a passband between 1 GHz and 60 GHz, and the one or more intermediate resonators have an unloaded quality factor greater than 400.

9. The distributed-element RF filter of claim 8 further comprising a conductive cover fastened to the substrate and electrically connected to the ground plane, wherein the conductive cover is disposed over the second surface of the substrate.

10. A distributed-element radio frequency (RF) filter comprising:
a dielectric substrate comprising a ground plane located on a surface of the substrate;
first and second resonators located on a surface of the substrate opposite the ground plane, each of the first and second resonators electrically coupled to a corresponding input/output (I/O) interface proximate a corresponding end of the substrate; and
one or more U-shaped or omega-shaped resonators located on the surface opposite the ground plane and between the first and second resonators, each U-shaped or omega-shaped resonator comprising first and second resonator end portions electrically connected to the ground plane by one or more conductors proximate a common side of the substrate,
wherein each of the resonators has an electrical length that is nominally one-half a wavelength of a center frequency of the filter.

11. The distributed-element RF filter of claim 10, wherein the first and second resonators have a common electrical length, and the one or more U-shaped or omega-shaped resonators have a common electrical length.

12. The distributed-element RF filter of claim 11, wherein the electrical length of the first and second resonators is greater than the electrical length of the one or more U-shaped or omega-shaped resonators.

13. The distributed-element RF filter of claim 10, wherein the first and second resonators have a length-to-width aspect ratio less than a length-to-width aspect ratio of the one or more U-shaped or omega-shaped resonators.

14. The distributed-element RF filter of claim 10 further comprising a conductive cover disposed over, and spaced apart from, the surface of the substrate on which the one or more resonators are located, the conductive cover electrically connected to the ground plane.

15. The distributed-element RF filter of claim 10 is a thin-film multi-pole filter having a passband between 1 GHz and 60 GHz, wherein the one or more U-shaped or omega-shaped resonators have an unloaded quality factor greater than 400.

16. A distributed-element radio frequency (RF) filter comprising:
a dielectric substrate between a ground plane at a surface of the substrate and a plurality of resonators at an opposite surface of the substrate;
the plurality of resonators comprising:
first and second resonators each electrically coupled to a corresponding input/output (I/O) interface proximate a corresponding end of the substrate; and
one or more intermediate resonators located between the first and second resonators,
each of the one or more intermediate resonators comprising a resonator portion between first and second end portions electrically connected to the ground plane by one or more conductors proximate a common side of the substrate.

17. The distributed-element RF filter of claim 16, wherein the resonator portions of each of the plurality of resonators comprise a portion having a U-shape or an omega-shape.

18. The distributed-element RF filter of claim 16, wherein an electrical length of the first and second resonators is greater than an electrical length of the one or more intermediate resonators.

19. The distributed-element RF filter of claim 16, wherein the first and second resonators have a length-to-width aspect ratio less than a length-to-width aspect ratio of the one or more intermediate resonators.

20. The distributed-element RF filter of claim 16 further comprising a conductive cover disposed over, and spaced apart from, the surface of the substrate on which the plurality of resonators are located, the conductive cover electrically connected to the ground plane.

21. The distributed-element RF filter of claim 16 is a thin-film multi-pole bandpass filter having a passband between 1 GHz and 60 GHz, wherein each of the one or more intermediate resonators having an electrical length that is nominally one-half a wavelength of a center frequency of the bandpass filter.
